(19) United States
(12) Patent Application Publication
(10) Pub. No.: US 2026/0038723 A1
(43) Pub. Date: Feb. 5, 2026

(54) METHOD AND SYSTEM FOR CLOSED-LOOP FEED FORWARD CONTROL OF ACTUATION OF A SOLENOID

(71) Applicant: SAIA-BURGESS LLC, VANDALIA, OH (US)

(72) Inventors: Kenneth S. LEVINE, Tipp City, OH (US); Adam STIENECKER, Tipp City, OH (US); Kurtis David KEENER, Gahanna, OH (US)

(21) Appl. No.: 19/351,900

(22) Filed: Oct. 7, 2025

Related U.S. Application Data
(63) Continuation of application No. PCT/US2023/018271, filed on Apr. 12, 2023.

(51) Int. Cl. H01F 7/18

(52) U.S. Cl. CPC H01F 7/1844; H01F 7/1805; H01F 2007/185; H01F 2007/1855; H01F 2007/1866

(57) ABSTRACT

A method and system are provided for controlling actuation of a solenoid having an armature movable relative to a wire coil. A processor performs a method that includes a repeating loop of: for an actuation cycle of the solenoid, determining a control signal parameter (CSP) value corresponding to a set point armature motion parameter (AMP) value based on a relational parameter array; controlling a signal generator to generate a control signal based on the determined CSP value, in the wire coil to initiate an actuation cycle of the solenoid; receiving from a sensor a measured AMP value for the actuation cycle of the solenoid; determining an error value between the measured AMP value and the set point AMP value for the actuation cycle of the solenoid; and updating the parameter array for a subsequent actuation cycle by changing the determined CSP value based on the error value.

### CROSS REFERENCE TO RELATED APPLICATIONS

This non-provisional patent application is a continuation application of PCT Application No. PCT/US2023/018271, filed with the USPTO on Apr. 12, 2023, which is incorporated herein by reference in its entirety.

### FIELD OF THE INVENTION

This disclosure relates generally to solenoids, and more particularly to controlling actuation of a solenoid, and to applied machine learning.

### BACKGROUND

Solenoids are actuators that convert electrical energy to mechanical energy using a ferromagnetic armature that moves relative to a wire coil used as an electromagnet. Solenoids are used in a variety of applications, such as warehouse control systems, material handling systems, and conveyor belt sorting systems. In such applications and others, it may be important to precisely control the kinematics of the armature, but this can be problematic when the solenoid system is dynamic due to changing operating conditions such as environmental conditions, wear or loads.

A “feed forward” control approach involves mapping the control signal inputs to the solenoid responses in a lookup table, and using the lookup table values to attempt to achieve a desired solenoid response for a given control signal input. An “in the loop” control approach involves using a sensor to measure motion of the armature, using a processor to determine any error between the measured value and a desired set point value, and using a feedback loop to vary the control signal in real time while the armature is moving during the actuation cycle to correct the error. In a combined approach, the feed forward approach can be used to determine an initial control signal, and the “in the loop” approach can be used to vary the control signal to correct the solenoid response while the armature is moving during the actuation cycle.

The “feed forward” approach is simpler to implement, but does not account for changes in solenoid system over time, and is best limited in application to well understood and stable solenoid systems. The “in the loop” approach can account for changes to the solenoid system over time, but requires a powerful processor and fast-acting circuitry that is capable of controlling fast motion profiles of the armature, which adds complexity and cost to the solenoid system.

Accordingly, there is a need in the art for methods and systems for controlling solenoid actuation that provide the benefits of the “in the loop” approach, while mitigating the need for and expense associated with powerful processors and fast-acting circuitry.

### SUMMARY OF THE INVENTION

In one aspect, the present disclosure includes a method for controlling actuation of a solenoid having an armature movable relative to a wire coil. The method is implemented by at least one processor operatively connected to at least one signal generator and at least one sensor. The method comprises a repeating control loop comprising:
for an actuation cycle of the solenoid, determining a control signal parameter (CSP) value corresponding to a set point armature motion parameter (AMP) value based on a parameter array stored in a memory and relating the CSP value to the set point AMP value;
controlling the at least one signal generator to generate a control signal based on the determined CSP value, in the wire coil to initiate the actuation cycle of the solenoid;
receiving from the at least one sensor a measured AMP value for the armature for the actuation cycle of the solenoid;
determining an error value between the measured AMP value and the set point AMP value for the actuation cycle of the solenoid; and
updating the parameter array for a subsequent actuation cycle of the solenoid by changing the determined CSP value based on the error value. In embodiments of the method, the CSP value of the control signal may comprise at least one PWM parameter that characterizes at least one phase of a pulse-width modulated (PWM) signal. The at least one PWM parameter may comprise a voltage or current magnitude and/or a duration of the at least one phase of the PWM signal. The at least one phase may be an acceleration phase that accelerates the armature in the actuation cycle, a braking phase that decelerates the armature in the actuation cycle, and/or a rest phase having a zero current magnitude between successive phases having non-zero current magnitudes. In embodiments, the at least one phase of the PWM signal comprises an acceleration phase that accelerates the armature in the actuation cycle, and a braking phase that decelerates the armature in the actuation cycle, and the PWM parameters are updated for each of the acceleration phase and the braking phase.

In embodiments of the method, the set point and measured AMP values comprise a duration of motion, a magnitude of rebound motion, and/or a velocity.

In another aspect, the present disclosure includes a system for controlling actuation of a solenoid having an armature movable relative to a wire coil. The system includes at least one signal generator for generating a control signal in the wire coil to actuate motion of the armature relative to the wire coil. The system includes at least one sensor for measuring an armature motion parameter (AMP) value. The system includes at least one processor operatively connected to the at least one signal generator, the at least one sensor, and at least one memory. The at least one memory comprises a non-transitory computer readable medium storing a set of instructions executable by the processor to implement the method and embodiments thereof, as described above.

In another aspect, the present disclosure includes a computer program product for controlling actuation of a solenoid. The computer program product comprises a non-transitory computer readable medium storing a set of instructions executable by a processor to implement the method and embodiments thereof, as described above.

### BRIEF DESCRIPTION OF THE DRAWINGS

The foregoing and other aspects of the disclosure will be better appreciated with reference to the attached drawings, as follows.

FIG. 1 shows a schematic depiction of an embodiment of a control system of the present disclosure operatively connected to a solenoid shown in medial sectional view.

FIG. 2 is a functional block diagram of an embodiment of a control system of the present disclosure operatively connected to a solenoid.

FIG. 3 shows one embodiment of a time-varying control signal used in an embodiment of the control method of the present disclosure for controlling solenoid actuation.

FIG. 4 shows another embodiment of a time-varying control signal used in an embodiment of the control method of the present disclosure for controlling solenoid actuation.

FIG. 5 shows an example of an optimal armature motion profile of an armature of a solenoid.

FIG. 6 shows an example of a sub-optimal armature motion profile of an armature of a solenoid, in which the armature arrives too quickly at a desired set point position.

FIG. 7 shows an example of a sub-optimal armature motion profile of an armature of a solenoid, in which the armature arrives too slowly at a desired set point position.

FIG. 8 is a conceptual representation of an embodiment of a parameter array used in an embodiment of the control method of the present disclosure for controlling solenoid actuation.

FIG. 9 is a flow chart of an embodiment of a control method of the present disclosure for controlling solenoid actuation.

### DETAILED DESCRIPTION OF THE PREFERRED EMBODIMENTS

### Interpretation.

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used in this document, “attached” in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, microcontroller units (MCU), central processing units (CPU), digital signal processors, and field programmable gate arrays (FPGAs).

Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments of the disclosures described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

### Solenoid

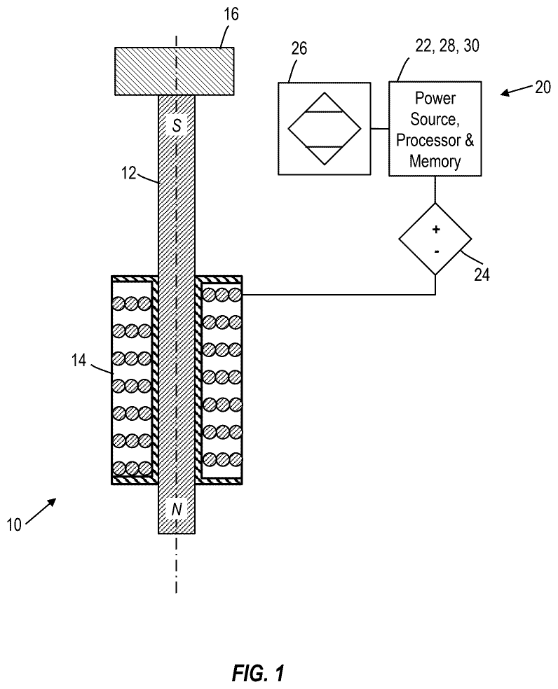

The present disclosure relates to a control system and control method for a solenoid. “Solenoid” as used herein refers to an actuator that converts electrical energy to mechanical energy using a ferromagnetic armature (e.g., a plunger or a rotor) that moves (e.g., slides within or rotates) relative to a wire coil used as an electromagnet. A solenoid may be a linear solenoid having an armature in the form of a sliding plunger, or a rotary solenoid that converts the sliding motion of the armature in the form of a plunger to rotational movement of another part of the solenoid, or a rotary solenoid having an armature in the form of a rotating rotor. Solenoids and their principle of operation are well known and do not by themselves constitute part of the present invention. For completeness, FIG. 1 shows a schematic depiction of an exemplary solenoid 10 including an armature 12 that slides within and relative to a wire coil 14, to actuate a load 16. Electric current flowing through the wire coil 14 in one direction (e.g., a positive current) induces a polarized magnetic field that acts upon the armature 12 to actuate translational motion of the armature 12 relative to the wire coil 14 in a first direction (e.g., toward the top of the drawing plane of FIG. 1). In embodiments of the solenoid, the direction of current flow through the wire coil 14 may be reversed (e.g., a negative current) to induce or decelerate motion of the armature 12 relative to the wire coil 14 in a second direction opposite to the first direction (e.g., toward the bottom of the drawing plane of FIG. 1). In embodiments, the solenoid 10 may have other parts (not shown) such as a spring that biases the armature 12 to an initial or neutral position, and in the case of a rotary solenoid, parts that translate linear motion of the armature 12 to rotary motion of another part such as bearings and inclined raceways. In embodiments, the load 16 actuated by the solenoid 10 may be a part of a material handling system or a conveyor belt sorting system. In embodiments, the load 16 may be a part that is to be rotatably actuated (e.g., a ratchet wheel) by the solenoid 10.

### Control System

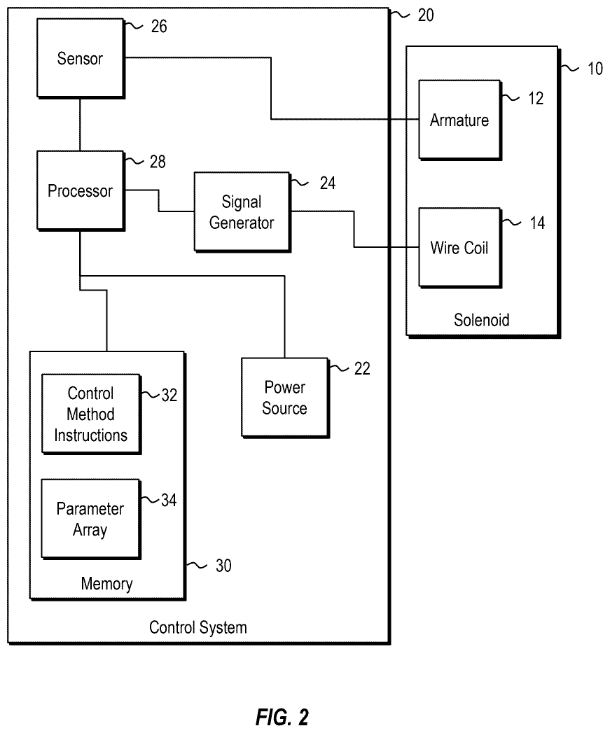

FIGS. 1 and 2 show a schematic depiction and a functional block diagram, respectively, of an embodiment of control system 20 of the present disclosure operatively connected to the solenoid 10. In general, the control system 20 includes at least one power source 22, at least one signal generator 24, at least one sensor 26, at least one processor 28, and at least one memory 30. The components are operatively connected to each other as shown by the connecting lines therebetween. Although FIG. 2 shows these components by single blocks, it will be understood that each component may include a plurality of components or sub-components that are operatively connected to each other. For example, the sensor 26 may include multiple sensors for measuring different armature motion parameters as discussed below. As another example, each of the processor 28 and the memory 30 may include a plurality of processors and memories, respectively, that are physically discrete and remote from each other, but operatively connected together (e.g., by wire or wireless connections, and/or a communications network such as an intranet or the Internet) in accordance with distributed computing techniques known in the art. For example, part of the processor 28 and memory 30 may be implemented by a processor and storage media of a server or computer workstation while other parts of the processor 28 and the memory 30 may be implemented by microcontroller units and associated firmware that are physically integrated with the solenoid 10, the signal generator 24 and/or the sensor 26.

### Power Source.

The power source 22 provides power directly or indirectly to the other parts of the control system 20, as may be required for their operation. As a non-limiting example, the power source 22 may be a grid-connected electric power source, or a standalone battery.

### Signal Generator, and Control Signal Parameters.

The signal generator 24 is used to generate an electric control signal, under the control of the processor 28, that is transmitted through the wire coil 14 to actuate the solenoid 10—i.e. induce motion of the armature 12 relative to the wire coil 14. Signal generators are known to persons skilled in the art as electronic devices that generate electrical signal defined by value(s) of one or more control signal parameter(s). As used herein, “control signal parameter” or “CSP” refers to a parameter that defines a characteristic of a control signal waveform. In embodiments, the CSP may comprise a plurality of parameters in combination. Non-limiting examples of a control signal parameter include a current or voltage magnitude (e.g., amplitude), a frequency, a phase duration or other temporal measure, and/or a shape characteristic of the control signal waveform. In embodiments where the control signal comprises a PWM signal, as described below, the control signal parameter may be referred to as a “PWM parameter”.

In one embodiment, the signal generator 24 is a digital signal generator that produces a pulse-width modulated (PWM) signal for the control signal that varies between a zero voltage and current in one phase, and a non-zero voltage and current in another phase. The digital signal generator 24 may include an H-bridge circuit under control of the processor 28. FIG. 3 shows an example of a PWM control signal characterized by an acceleration phase having an acceleration phase magnitude, iₐ, and an acceleration phase duration, Δtₐ. This control signal may be used for a linear solenoid or a rotary solenoid that reacts only to electric current flow in one direction through the wire coil 14 as indicated by the positive current of the acceleration phase.

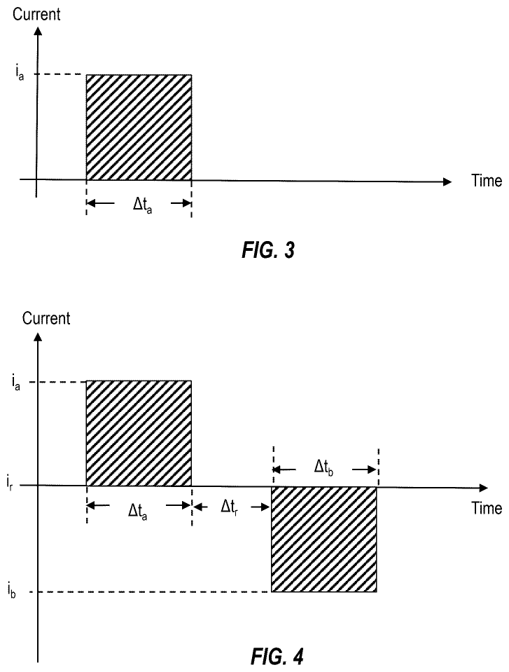

FIG. 4 shows another example of a PWM control signal characterized by an acceleration phase as described for FIG. 3, followed by a rest phase having a zero current magnitude, iᵣ and rest phase duration, Δtᵣ, subsequently followed by a braking phase having a braking phase magnitude, in, and a braking phase duration, Δt_{b}. This control signal may be used for a bidirectional rotary solenoid that rotates in a first direction when electric current flows through the wire coil 14 in one direction indicated by the positive current of the acceleration phase, and rotates in a second direction opposite to the first direction when electric current flows through the wire coil 14 in the opposite direction indicated by the negative current of the braking phase. The acceleration phase may be used to accelerate the armature 12 and the subsequent braking phase may be used to decelerate (or brake) the armature 12, within the same actuation cycle of the solenoid 10.

In FIGS. 3 and 4, the phase magnitudes are expressed in terms of current values, iₐ, iᵣ, and i_{b}, but it will be appreciated that they may also be expressed in terms of corresponding voltage values, Vₐ, Vᵣ, and V_{b}, respectively.

### Sensor, and Armature Motion Parameters.

The sensor 26 is used to directly or indirectly measure an armature motion parameter. As used herein, an “armature motion parameter” or “AMP” refers to a metric of the motion of the armature 12. Non-limiting examples of an armature motion parameter include a position (e.g. a displacement) of the armature 12 relative to a fixed reference point, a time required for the armature 12 to travel to a specified position, or a velocity or acceleration of the armature 12 relative to the wire coil 14. In embodiments, the sensor 26 may be implemented by a variety of contact or non-contact sensors known in the art with non-limiting examples including accelerometers (e.g. (MEMS)-based accelerometers), capacitive microelectromechanical systems displacement sensors, eddy-current sensors, Hall effect sensors, inductive sensors, optical sensors, photo diode sensors, variable differential transform (VDT) sensors, encoders, potentiometers, and so forth.

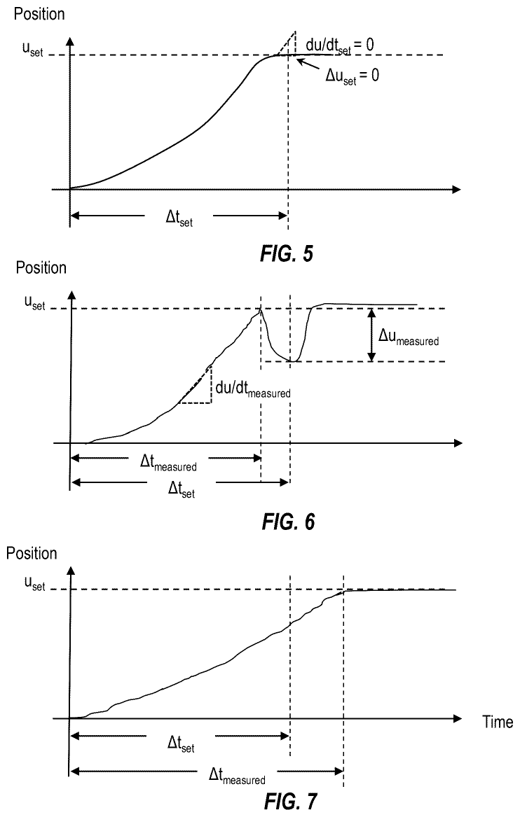

In one embodiment, the sensor 26 measures the position of the armature 12 over a time period to create an armature motion profile, from which the velocity of the armature 12 can be determined as a derivative of positional change over time. FIGS. 5 to 7 are examples of such armature motion profiles captured during an actuation cycle of the solenoid 10. FIG. 5 shows an optimal armature motion profile in which the armature 12 reaches a desired set point position, uₛₑₜ, at a desired set point time interval, Δtₛₑₜ, at which time the armature 12 has a zero or negligibly small set point velocity, du/dtₛₑₜ (as indicated by the horizontal slope of the curve), and a zero or negligibly small set point rebound, Δuₛₑₜ.

FIG. 6 shows a sub-optimal armature motion profile in which the armature 12 moves too quickly and reaches the set point position, uₛₑₜ, at a measured time interval, Δt_{measured}, prematurely before the desired set point time interval, Δtₛₑₜ. Further, the armature 12 has a significant non-zero velocity, du/dt_{measured} (as indicated by the non-horizontal slope of the curve in FIG. 6) upon reaching the set point position, uₛₑₜ, that results in the armature 12 exhibiting an undesirable bounce or rebound motion, having a measured rebound magnitude Δu_{measured}. This rebound is undesirable for a variety of reasons, including lack of control and prolonging the overall actual actuation cycle time until the armature 12 returns at rest to the set point position, uₛₑₜ. This sub-optimal motion profile may be due to the signal generator 24 generating a control signal with an acceleration phase that supplies excessive energy to the armature 12, and/or a braking phase that supplies insufficient energy to the armature 12.

FIG. 7 shows another sub-optimal armature motion profile in which the armature 12 moves too slowly and does not reach the set point position, uₛₑₜ, until a measured time interval, Δt_{measured}, that exceeds the desired set point time interval, Δtₛₑₜ. This sub-optimal armature motion profile may be due to the signal generator 24 generating a control signal with an acceleration phase that supplies insufficient energy to the armature 12, and/or a braking phase that supplies excessive energy to the armature 12.

### Processor.

The processor 28 is operatively connected to the signal generator 24 to control the signal generator 24 to generate control signals for the wire coil 14 in accordance with one or more selected control signal parameter value(s). For example, in embodiments in which the signal generator 24 includes the H-bridge circuit, the processor 28 may be connected to the H-bridge circuit via a driver circuit, as known in the art, to actuate the switches of the H-bridge circuit to produce the aforementioned control signals. The processor 28 is also operatively connected to the sensor 26 to receive one or more armature motion parameter values that is/are measured by the sensor 26. The processor 28 is also operatively connected to the memory 30, as described below.

### Memory, and Parameter Array.

The memory 30 may be considered as a computer-program product of the present disclosure. The memory 30 stores control method instructions 32 that are executable by the processor 28 to implement a control method as described below.

The memory 30 also stores a parameter array 34. In embodiments, the memory 30 or portion thereof that stores the parameter array 34 may be physically integrated with the solenoid 10, such as firmware stored as part of a programmable microcontroller unit physically integrated with the solenoid 10. “Parameter array” as used herein refers to a data structure that stores a relationship between control signal parameter (CSP) values, and armature motion parameter (AMP) values. In embodiments, the data structure may be implemented by a lookup table that allows for efficient run-time processing by directly addressing one or more armature motion parameter values to one or more control signal parameter values. In other embodiments, the parameter array 34 may be implemented by other relational data structures known in the art such as a hash table, or other data structure that can be used to store or determine paired relationships between one or more armature motion parameter values and one or more control signal parameter values.

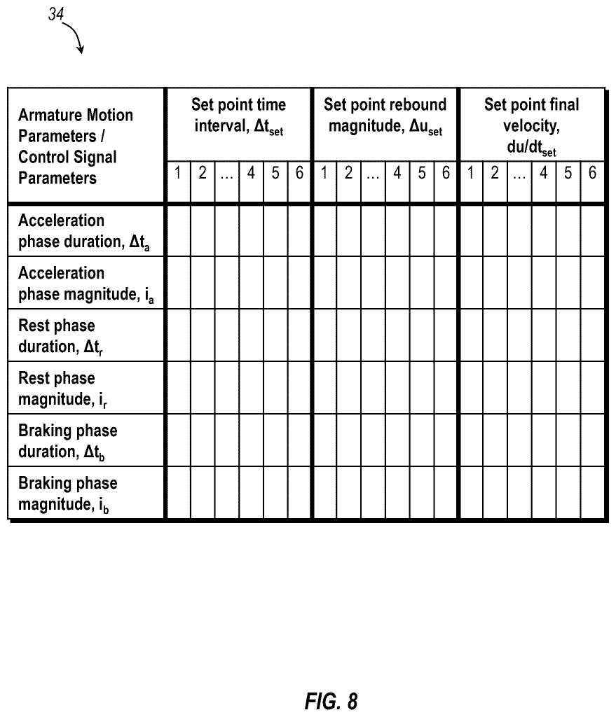

FIG. 8 is a conceptual representation of a parameter array 34 that relates control signal parameter values to armature motion parameter values. In this embodiment, the control signal parameter values are the acceleration phase, rest phase, and braking phase magnitudes expressed as current values, iₐ, iᵣ, and i_{b}, and their durations Δtₐ, Δtᵣ, and Δt_{b}, as described above with reference to FIGS. 3 and 4. In other embodiments, the control signal parameter values may be one or a combination of these values, or other value(s) indicative of the control signal waveform. In this embodiment, the armature motion parameters are the set point time interval, Δtₛₑₜ, a set point rebound magnitude, Δuₛₑₜ, and a set point velocity, du/dtₛₑₜ for a set point position, uₛₑₜ, as described above with reference to FIG. 5. In other embodiments, the armature motion parameters values may be one or a combination of these values, or other value(s) indicative of the armature motion.

In FIG. 8, the cells of the parameter array 34 are shown as blank for illustrative purposes, but in practice, they are populated with values (e.g., numerical values). The populated values may initially be based on empirical calibration of the solenoid 10, a rational model of the solenoid 10, arbitrary seed or training data values, or a combination of the foregoing. These values are updated during performance of the control method as described below. In this embodiment of the parameter array 34, each value of one of the armature motion parameters is paired with one value of each of the control signal parameters. In other embodiments, values of multiple armature motion parameters may be related to one or more control signal parameters. Accordingly, it will be understood that the parameter array 34 may map armature motion parameter(s) to control signal parameter(s) in a one-to-one, one-to-many, many-to-one, or many-to-many relationship.

### Control Method and Examples

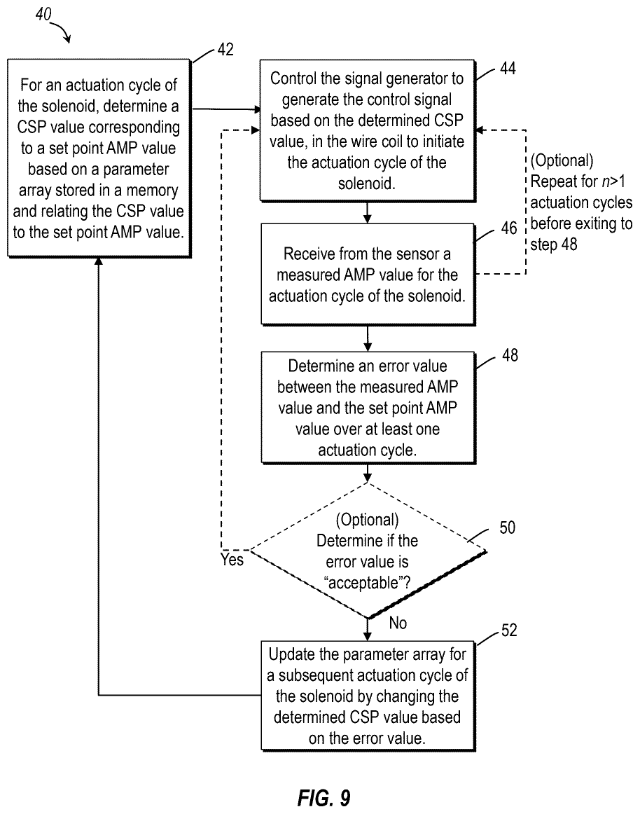

FIG. 9 is a flow chart of an embodiment of a control method 40 of the present disclosure for controlling actuation of the solenoid 10. Optional steps are shown in dashed line. In FIG. 9, the “CSP value” refers to one or more control signal parameter values. For example, referring to FIGS. 3 and 4, the CSP value may include specified value(s) for one or more of the acceleration phase, rest phase, and braking phase magnitudes, iₐ, iᵣ, and i_{b}, and their durations Δtₐ, Δtᵣ, and Δt_{b}. The “set point AMP value” refers to one or more desired value(s) of armature motion parameter(s) for the armature 12. For example, referring to FIG. 5, the setpoint AMP value may include specified value(s) for one or more of the set point time interval, Δtₛₑₜ, for the armature 12 to reach the set point position uₛₑₜ, a set point velocity du/dtₛₑₜ of the armature 12 upon reaching the set point position uₛₑₜ, and a set point rebound magnitude, Δuₛₑₜ.

The steps of the control method 40 are performed by the processor 28 executing the control method instructions 32 stored by the memory 30. In embodiments, the control method 40 may be performed while the solenoid 10 is in service in an industrial system, such as a warehouse control system, material handling system, or conveyor belt sorting system. In such embodiments, the magnitude of the load 16 (FIG. 1) actuated by the solenoid 10, the operating conditions and/or the wear of the solenoid 10 may vary over time while the control method 40 is performed. The control method 40 includes a repeating control loop as follows.

At step 42, the processor 28 determines, for an actuation cycle of the solenoid 10, a CSP value corresponding to a set point armature motion parameter value based on the parameter array 34 stored in the memory 30 and relating the control signal parameter value to the set point armature motion parameter value. For example, suppose that the set point AMP value includes a set point time interval, Δtₛₑₜ, of 0.5 seconds, a set point velocity, du/dtₛₑₜ, of 0 m/s when the armature 12 reaches the set point position, uₛₑₜ, and a set point rebound magnitude, Δuₛₑₜ, of 0 mm. For example, in one embodiment in which the parameter array 34 is a lookup table, the processor 28 uses the set point AMP value as a key to address a corresponding CSP value in the parameter array 34.

At step 44, the processor 28 controls the signal generator 24 to generate the control signal based on the determined CSP value in the wire coil 14 to actuate movement of the armature 12 relative to the wire coil 14 to initiate the actuation cycle of the solenoid 10. As used herein, the control signal being “based on” the determined CSP value includes the control signal being characterized by a control signal parameter value that is derived from the CSP value determined in step 42.

At step 46, the processor 28 receives, from the sensor 26, a measured AMP value for the actuation cycle of the solenoid 10. For example, the sensor 26 may be used to measure the position of the armature 12 relative to a fixed reference point over time to acquire a motion profile during the actuation cycle, as shown in FIG. 6 or 7. From this motion profile, the processor 28 may determine a measured time interval, Δt_{measured}, for the armature 12 to reach the set point position, uₛₑₜ, a measured actual velocity of the armature 12, du/dt_{measured}, upon reaching the set point position, uₛₑₜ, and a measured rebound magnitude, Δu_{measured}.

At step 48, the processor 28 determines an error value between the measured armature motion parameter value and the set point armature motion parameter value. As an example, the error value may be determined as a difference between or a factor of the set point and corresponding measured AMP value.

At optional step 50, the processor 28 determines whether the error value is “acceptable”. For example, this may involve determining whether the error value is within a pre-defined threshold range or tolerance. If the error value is acceptable, and presuming that the desired set point AMP value remains the same for a subsequent actuation cycle, then the method 40 may return directly to step 44 for the subsequent actuation cycle of the solenoid 10. Conversely, if the error value is not acceptable, then the method proceeds to step 52. In embodiments, the method may omit step 50 and proceed directly from step 48 to step 52.

At step 52, the processor 28 updates the parameter array 34 for a subsequent actuation cycle of the solenoid by changing the determined CSP value based on the error value. The change to the CSP value may be generalized by the following formula:

$${CSP}_{i + 1} = {CSP}_{i} + func ( error value )$$

where: CSPᵢ₊₁ is the control signal parameter value after being updated for the subsequent actuation cycle; CSPᵢ is the control signal parameter value determined in step 44 based on the parameter array 34 for the current actuation cycle; and func(error) is a relationship or algorithm that determines the update to CSPᵢ based on the error value. The present disclosure is not limited by any particular relationship or algorithm for determining the change in the CSP value based on the error value. For example, determining the change may be based simply on the Boolean test of the error value being “unacceptable” (e.g., step 50), without mathematical operation on the error value itself. In another example, determining the change may involve the processor 28 performing a pre-defined mathematical operation on the existing CSP value in the parameter array 34 and the error value. For instance, the memory 30 may store a formula to increase or decrease the existing CSP value by an amount based on the error value. The formula may be based on empirical calibration of the solenoid 10, a rational model of the solenoid 10, or interpolation or extrapolation of CSP values in the parameter array 34. In another example, determining the change may involve a single or multivariate regression model that changes one or multiple CSP values simultaneously in the parameter array 34. In particular, minimizing rebound, Δu_{measured}, may require adjusting multiple CSP variables simultaneously to observe the constraint of the set point time interval, Δtₛₑₜ.

Referring to FIG. 6, it will be recalled that this armature motion profile shows the case of the armature 12 arriving too quickly at the desired set point position. In this example, in step 48, the processor 28 may determine that: the measured time interval, Δt_{measured}, is less than the set point time interval, Δtₛₑₜ; the measured velocity, du/dt measured when the armature 12 reaches the set point position is non-zero; and the measured rebound magnitude Δu_{measured} is non-zero. This would result in non-zero error values for these armature motion parameters when compared to the set point armature motion parameters shown in FIG. 5. In step 52, the method can adjust the CSP values of the parameter array 34 by decreasing the acceleration phase duration, Δtₐ, and/or the acceleration phase magnitude, iₐ, and/or increasing the rest phase duration, Δtᵣ, and/or increasing the braking phase duration, Δt_{b}, and/or the braking phase magnitude, id. These changes will reduce the energy applied by the acceleration phase and/or increase the energy applied the braking phase, of the control signal in a subsequent actuation of the armature 12, with a view to reducing the error values.

Referring to FIG. 7, it will be recalled that this armature motion profile shows a case of the armature 12 arriving too slowly at the desired set point position. In this example, in step 48, the processor 28 may determine that the measured time interval, Δt_{measured}, is greater than the set point time interval, Δtₛₑₜ. This would result in a non-zero error value for this armature motion parameter when compared to the set point armature motion parameter shown in FIG. 5. In step 52, the method can adjust the CSP value of the parameter array 34 by increasing the acceleration phase duration, Δtₐ, and/or the acceleration phase magnitude, iₐ, and/or decreasing the rest phase duration, Δtᵣ, and/or decreasing the braking phase duration, Δt_{d}, and/or the braking phase current magnitude, i_{b}. These changes will increase the energy applied by the acceleration phase and/or decrease the energy applied the braking phase, of the control signal in a subsequent actuation of the armature 12, with a view to reducing the error value.

In embodiments of the method, steps 48 to 52 may be performed after a single iteration of steps 44 to 46 corresponding to a single actuation cycle of the solenoid 10. In other embodiments, step 48 to 52 may be performed only after multiple iteration of steps 44 to 60 corresponding to multiple actuation cycles of the solenoid 10. This is shown in FIG. 9, by the optional loop of steps 44 to 46 for a number, n>1, actuation cycles. In such embodiments, step 48 may determine an error value for one of the actuation cycles for computation efficiency. Alternatively, step 48 may determine an error value based on a plurality of the actuation cycles, such as a sum or average of the error values of the actuation cycles. In solenoid systems that are dynamic in nature (e.g., due to changing operating conditions such as environmental conditions, wear, or loads), this latter approach may smooth variations in error values over the multiple actuation cycles, and the resulting determined changes to the CSP values of the parameter array 34. This may allow for more stable convergence between the set point and measured AMP value.

After step 52, the armature 12 returns to an initial position and is ready for a subsequent actuation cycle. The method returns to step 42, and repeats the control loop for the subsequent actuation cycle of the solenoid 10. On account of the parameter array 34 having been updated in step 52, however, the CSP value that is determined in step 42, the measured AMP value at step 46 and the error value determined in step 48 may differ from those of the previous iteration of these steps for eth previous actuation cycle. With appropriate adjustment of the CSP values in the parameter array 34, the measured AMP value may converge toward the set point AMP value, over one or more actuation cycles of the solenoid 10.

In comparison with the “feed forward” approach described in the Background section, the present method may be more adaptable to solenoid systems that are dynamic in nature (e.g., due to changing operating conditions such as environmental conditions, wear, or loads). In comparison with the “in the loop” approach described in the Background section, the present method avoids attempting to alter the motion of the armature 12 during an actuation cycle of the solenoid 10. Instead, the present method only uses the updated parameter array 34 to determine the control signal in a subsequent actuation cycle of the solenoid. Accordingly, the present method may be less computationally demanding, and avoid the need for powerful processors and fast-acting circuitry, which may allow for lower complexity and costs of the control system.

While the description contained herein constitutes a plurality of embodiments of the present disclosure, it will be appreciated that the present disclosure is susceptible to further modification and change without departing from the fair meaning of the accompanying claims.

### PART LIST

10 Solenoid
12 Solenoid, armature
14 Solenoid, wire coil
16 Load
20 Control system
22 Control system, power source
24 Control system, signal generator
26 Control system, sensor
28 Control system, processor
30 Control system, memory
32 Control system, memory, control method instructions
34 Control system, memory, parameter array
40-52 Control method, and steps thereof

1. A method for controlling actuation of a solenoid comprising an armature movable relative to a wire coil, the method implemented by at least one processor operatively connected to at least one signal generator and at least one sensor, and comprising a repeating control loop comprising:
for an actuation cycle of the solenoid, determining a control signal parameter (CSP) value corresponding to a set point armature motion parameter (AMP) value based on a parameter array stored in a memory and relating the CSP value to the set point AMP value;
controlling the at least one signal generator to generate a control signal based on the determined CSP value, in the wire coil to initiate the actuation cycle of the solenoid;
receiving from the at least one sensor a measured AMP value for the armature for the actuation cycle of the solenoid;
determining an error value between the measured AMP value and the set point AMP value for the actuation cycle of the solenoid; and
updating the parameter array for a subsequent actuation cycle of the solenoid by changing the determined CSP value based on the error value.

2. The method of claim 1, wherein the CSP value of the control signal comprises at least one PWM parameter that characterizes at least one phase of a pulse-width modulated (PWM) signal.

3. The method of claim 2, wherein the at least one PWM parameter comprises a current or voltage magnitude of the at least one phase of the PWM signal.

4. The method of claim 2, wherein the at least one PWM parameter comprises a duration of the at least one phase of the PWM signal.

5. The method of claim 2, wherein the at least one phase of the PWM signal comprises an acceleration phase that accelerates the armature in the actuation cycle.

6. The method of claim 2, where the at least one phase of the PWM signal comprises a braking phase that decelerates the armature in the actuation cycle.

7. The method of claim 2, wherein the at least one phase of the PWM signal comprises a rest phase having a zero current magnitude between successive phases having non-zero current magnitudes.

8. The method of claim 2, wherein the at least one phase of the PWM signal comprises an acceleration phase that accelerates the armature in the actuation cycle, and a braking phase that decelerates the armature in the actuation cycle, and the PWM parameters are updated for each of the acceleration phase and the braking phase.

9. The method of claim 1, wherein the set point and measured AMP values comprise a duration of motion.

10. The method of claim 1, wherein the set point and measured AMP values comprise a magnitude of rebound motion.

11. The method of claim 1, wherein the set point and measured AMP values comprise a velocity.

12. A system for controlling actuation of a solenoid comprising an armature movable relative to a wire coil, the system comprising:
at least one signal generator for generating a control signal in the wire coil to actuate motion of the armature relative to the wire coil;
at least one sensor for measuring an armature motion parameter (AMP) value;
at least one processor operatively connected to the at least one signal generator, the at least one sensor, and at least one memory comprising a non-transitory computer readable medium storing a set of instructions executable by the processor to implement a method comprising a repeating control loop comprising:
for an actuation cycle of the solenoid, determining a control signal parameter (CSP) value corresponding to a set point AMP value based on a parameter array stored in a memory and relating the CSP value to the set point AMP value;
controlling the at least one signal generator to generate the control signal based on the determined CSP value, in the wire coil to initiate the actuation cycle of the solenoid;
receiving from the at least one sensor a measured AMP value for the armature for the actuation cycle of the solenoid;
determining an error value between the measured AMP value and the set point AMP value for the actuation cycle of the solenoid; and
updating the parameter array for a subsequent actuation cycle of the solenoid by changing the determined CSP value based on the error value.

13. The system of claim 12, wherein the CSP value of the control signal comprises at least one PWM parameter that characterizes at least one phase of a pulse-width modulated (PWM) signal.

14. The system of claim 13, wherein the at least one PWM parameter comprises a voltage or current magnitude of the at least one phase of the PWM signal.

15. The system of claim 13, wherein the at least one PWM parameter comprises a duration of the at least one phase of the PWM signal.

16. The system of claim 13, wherein the at least one phase of the PWM signal comprises an acceleration phase that accelerates the armature in the actuation cycle.

17. The system of claim 13, wherein the at least one phase of the PWM signal comprises a braking phase that decelerates the armature in the actuation cycle.

18. The system of claim 13, wherein the at least one phase of the PWM signal comprises a rest phase having a zero current magnitude between successive phases having non-zero current magnitudes.

19. The system of claim 13, wherein the at least one phase of the PWM signal comprises an acceleration phase that accelerates the armature in the actuation cycle, and a braking phase that decelerates the armature in the actuation cycle, and the PWM parameters are updated for each of the acceleration phase and the braking phase.

20. The system of claim 12, wherein the set point and measured AMP values comprise a duration of motion.

21. The system of claim 12, wherein the set point and measured AMP values comprise a magnitude of rebound motion.

22. The system of claim 12, wherein the set point and measured AMP values comprise a velocity.
